(19) United States
(12) Patent Application Publication
(10) Pub. No.: US 2005/0094371 A1
(43) Pub. Date: May 5, 2005

(54) Electronic device and heat-dissipating module thereof

(76) Inventor: Chih-Hsi Lai, Sindian City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/792,300

(22) Filed: Mar. 3, 2004

(30) Foreign Application Priority Data
Nov. 3, 2003 (TW) 92130694

(51) Int. Cl. G06F 1/20

(52) U.S. Cl. 361/687; 361/695; 165/80.3; 165/122

(57) ABSTRACT

An electronic device. A host is equipped with a circuit including a first and second heat source. A heat-dissipating module has a conductive assembly disposed on the first heat source and a first fan assembly located between a surroundings and the conductive assembly. As an initial airflow of the surroundings passes the first heat source, its temperature increases, but is lower than the second heat source. As the airflow passes the second heat source, temperature increases again, and is then expelled to the exterior of the host.

### BACKGROUND OF THE INVENTION

1. Field of the Invention

The present inventions relates to an electronic device, and in particular to an electronic device utilizing a heat-dissipating module with enhanced airflow.

2. Description of the Related Art

Electronic products such as notebooks require high performance heat dissipation. Except water coolers, dissipating structures, such as a fin set and fan or blower, are typical systems.

Enhanced efficiency of heat exchange speeds circulation of airflow between the inside and the exterior of the notebook, but noise and vibration are increased thereby. Particularly, if the site of a fin set is close to an inlet or gas grille vent, noise is directly transmitted therethrough to the exterior of the notebook, affecting the operator directly.

Further, in addition to CPU, other components such as VCC, RAM (DDR, SO-DIMM), chipset, VGA CHIP, Choke, MOS, etc., also generate heat. Methods for dissipating heat from these components can include an additional fan, adopting a single independent heat sink, or sharing airflow from the CPU fan. However, loading of the CPU heat-dissipating system accordingly increases, and temperature regulation of CPU is also degraded.

FIG. 1 is a plane view of a conventional heat-dissipation system for a notebook N′. The notebook N′ comprises a housing B0, a motherboard B1 and a heat-dissipating device B2. The motherboard B1 and the heat-dissipating device B2 are disposed in the housing B0, and the heat-dissipating device B2 performs heat exchange between the inner space of the housing B0 and the exterior of the housing B0. An outlet b10 is formed on a sidewall of the housing B0. Components such as CPU b11, chipsets b12/b13, RAM (DDR, SO-DIMM) b14 and VCC b15 are disposed on the motherboard B1.

The heat-dissipating device B2 comprises a conductive pipe b20, two fans b21/b22 and two heat-exchange units (metallic fins) b23/b24. The heat-exchange unit b23 is disposed on CPU b11, and the heat-exchange unit b24 is disposed near the outlet b10. The conductive pipe b20 is connected between the heat-exchange unit b23 and the heat-exchange unit b24, so that part of the heat from CPU b11 is transmitted to the heat-exchange unit b24 through the conductive pipe b20. The fans b21/b22 are disposed on the motherboard B1 relative to the heat-exchange units b23/b24, respectively.

As the fans b21/b22 rotate, airflow passes the heat-exchange units b23/b24, noise and vibration are increased thereby, and noise directly transmits through the outlet b10 to the surroundings, affecting usability. In addition, because the heat-exchange units b23/b24 are located between the fans b21/b22 and the outflow area, i.e., the heat-exchange units b23/b24 are closer to the outlet b10 of the housing B0 than the fans b21/b22, or the fans b21/b22 are located deeper in the housing B0, temperature at intake is high and air from the surroundings cannot be smoothly moved into the housing B0, both of which affect efficiency of the fans b21/b22.

### SUMMARY OF THE INVENTION

Accordingly, an object of the invention is to provide an electronic device with a high-performance heat-dissipating module.

The invention provides a host and a heat-dissipating module. The host comprises a housing with a circuit disposed therein. The circuit has a first heat source and a second heat source. The heat-dissipating module comprises a conductive assembly disposed on the first heat source and a first fan assembly located between the conductive assembly and the exterior of the housing, i.e., the surrounding of the host. As airflow passes the first heat source, but not reaching the second heat source, its temperature risen, although heat-absorption capacity is not yet depleted. Then, as airflow passes the second heat source, its temperature increases again, and conveys absorbed heat to the exterior.

By “Reverse Thinking”, the heat-dissipating module of the invention thus provides superior cooling for both the first heat and second heat sources, dissipating and expelling absorbed heat to the exterior, such that temperature regulation of CPU is not influenced by other components on the motherboard, and circulation of airflow between the inside and the exterior of the housing is enhanced.

A detailed description is given in the following embodiments with reference to the accompanying drawings.

### BRIEF DESCRIPTION OF THE DRAWINGS

The present invention is more fully understood by reading the subsequent detailed description and examples with references made to the accompanying drawings, wherein:

FIG. 1 is a plane view of the inner structure of a related notebook (N′);

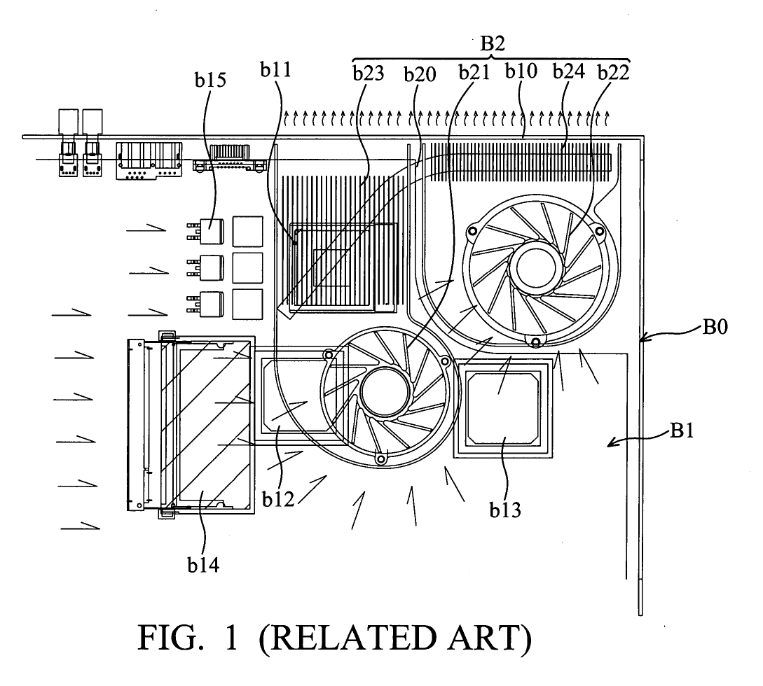

FIG. 2 is a perspective view of an electronic device (N1) providing a heat-dissipating module (M1) according to a first embodiment of the present invention;

FIG. 3 is a plane view of the inner structure of the electronic device (N1) in FIG. 2; and

FIG. 4 is a perspective view of an electronic device (N2) providing a heat-dissipating module (M2) according to a second embodiment of the present invention.

### DETAILED DESCRIPTION OF THE INVENTION

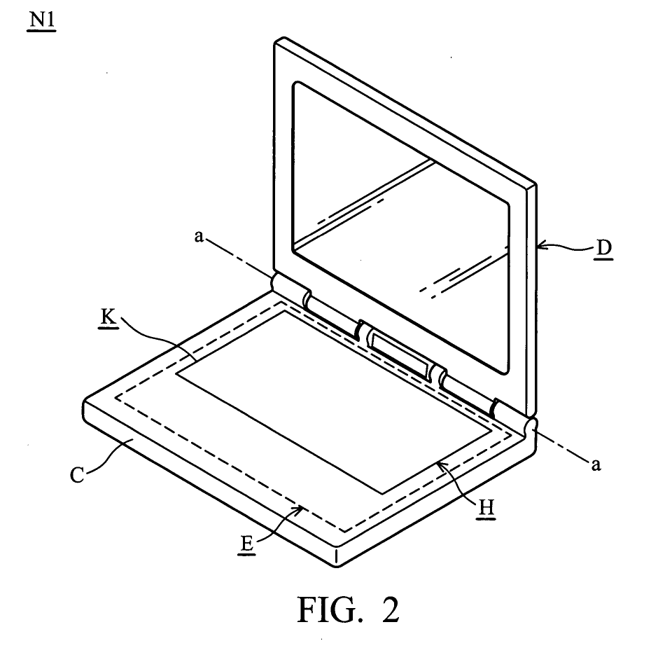

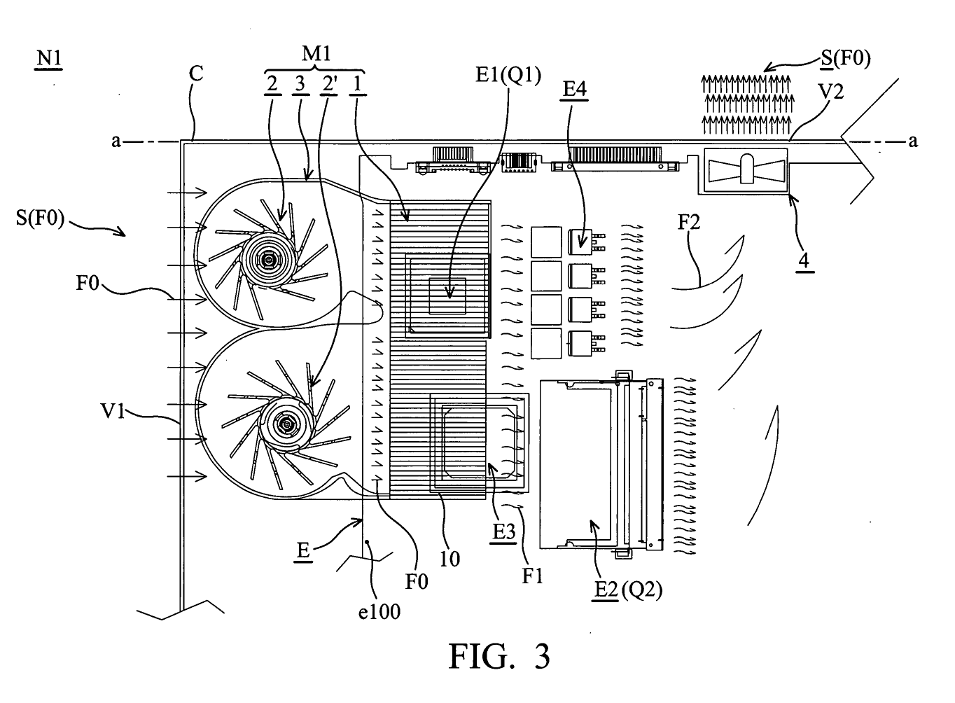

Referring to FIG. 2, in a first embodiment of the invention, an electronic device N1 such as a notebook provides a heat-dissipating module M1 (see FIG. 3) providing heat transfer and convection from components to the exterior of the notebook. The heat-dissipating module M1 of the invention is not limited to the notebook shown or other electronic devices, but is applicable to various devices generating heat.

In FIG. 2, the electronic device N1 comprises a host H, a display unit D pivotally connected to the host H about an axis a-a, a keyboard K and the heat-dissipating module M1 (shown in FIG. 3). The host H comprises a rectangular housing C and a circuit E disposed in the housing C. The display unit D and the keyboard K disposed on the housing C are electronically connected to the circuit E. The heat-dissipating module M1 is disposed on the circuit E in the housing C providing heat transfer and convection from the various components disposed on circuit E to the exterior of the notebook N1.

FIG. 3 is a plane view of the inner structure of the electronic device N1 located in a surrounding S in FIG. 2. The circuit E has a motherboard e100, CPU E1, Memory E2, VGA chip E3 and other components E4 such as VCC, Choke, MOS, etc. CPU E1, Memory E2 and VGA chip E3 are electronically connected to the motherboard e100, and the components E4 are electronically connected to the motherboard e100 by metal pins. All these electronic components generate heat during operation of the electronic device N1.

If a first heat source Q1 and a second heat source Q2 respectively represent CPU E1 and memories E2, heat from the first heat source Q1 is not less than that from the second heat source Q2, measured by unit time.

An inlet V1 and an outlet V2 are respectively formed on two sidewalls of the housing C, with the motherboard e100 located therebetween.

The heat-dissipating module M1 comprises a conductive assembly 1, a first fan assembly including two fan units 2/2′, a guide plate 3 and a second fan assembly 4. The conductive assembly 1 comprises a heat-transfer unit 10 connected to the first heat source Q1. In this embodiment, the heat-transfer unit 10 comprises a fin structure of metal, such as aluminum.

The fan units 2/2′ of the first fan assembly, substantially surrounded by the guide plate 3, are juxtaposed and placed between the inlet V1 of the housing C and the first heat source Q1 of the motherboard e100. The second fan assembly 4 is placed on the outlet V2 of the housing C.

By rotating the fan units 2/2′ of the first fan assembly, an initial airflow F0 from the surroundings S, i.e., the exterior of the host H, enters the housing C via the inlet V1 and passes the motherboard e100 and the heat-transfer unit 10 of the conductive assembly 1 via the guide plate 3 to the inner regions of the housing C. Then, a heated airflow F2 with higher temperature than the initial airflow F0 is transmitted to the surroundings S or exterior of the host H via the fan assembly 4 placed on the outlet V2 of the housing C. Unlike the fan units 2/2′ of the first fan assembly, the heat-transfer unit 10 is disposed on the inner region of the housing C away from the inlet V1.

As the pressurized initial airflow F0 passes the heat-transfer unit 10 of the conductive assembly 1 at high speed, noise generated is shielded by the motherboard e100 of the circuit E and the keyboard K (see in FIG. 2).

Since the fan units 2/2′ of the first fan assembly are placed near the outlet V2 of the housing C, temperature of the initial airflow F0 driven by the fan units 2/2′ is substantially the same as the surroundings S, and much lower than that of the first heat source Q1 or second heat source Q2. That is to say, temperature of the initial airflow F0 driven by the fan units 2/2′ is the lowest of any region in the housing C, making its heat-absorption capacity with respect to the first heat source Q1 is the highest, such that efficiency of heat transfer increases.

As the initial airflow F0 passes through the first heat source Q1, the conductive assembly 1 and VGA chip E3, prior to reaching the second heat source Q2 and the components E4, its temperature increase and a first airflow F1 is formed to be with temperature higher than that of the initial airflow F0, but lower than that of the second heat source Q2 and the components E4 (because the amount of the first airflow F1 is massive). Then, as the first airflow F1 passes through the second heat source Q2 and the components E4, its temperature rises again and a second airflow F2 is formed to be with temperature higher than that of the first airflow F1. Temperature ingredient yields between the first airflow F1 and the second airflow F2, and thus the first airflow F1 still has capacity to absorb heat from the second heat source Q2 and the components E4. In other words, although some heat dissipation capacity is expended, sufficient remains to absorb heat from the second heat source Q2 and the components E4.

With the heat-dissipating module M1 for the electronic device N1 of the present invention, heat from the second heat source Q2 and the components E4 is efficiently dissipated by the first airflow F1, and temperature of the first heat source Q1 is not directly influenced by heat from the second heat source Q2 and the components E4. In addition, the first airflow F1, from the first heat source Q1 and VGA chip E3, has capacity to absorb heat from the second heat source Q2 and the components E4 before expulsion to the surroundings S via the fan assembly 4.

It is noted that the present invention applies “Reverse Thinking” to dissipate heat from these components disposed on the motherboard e100 of the electronic device N1. That is to say, heat from the heat-transfer unit 10 of the conductive assembly 1 disposed in the housing C is dissipated by the fan units 2/2′ of the first fan assembly disposed near the outlet V2, so that efficiency of the heat-dissipating module M1 increases.

It is recommended that the electronic device N1 is provided with the second fan assembly 4 as temperature of the second airflow F2 is too high or and airflow passing through the host H needs to be increased. If the computer device N1 is to be provided with the second fan assembly 4, airflow rate, power and size of the second fan assembly 4 must be considered.

According to experimental data, it is clear that if the power of heat produced by the first heat source Q1 is substantially equal to 100 W, temperature of the first airflow F1 will be 48° C., with temperature of the surroundings S (initial airflow F0) at 35° C. with a maximum of airflow of the fan units 2/2′ at 8 CFM, unshielded during testing with zero static pressure. As the second fan assembly 4 is not provided, the outlet V2 is retained on the sidewall of the housing C, away from the location of the fan units 2/2′.

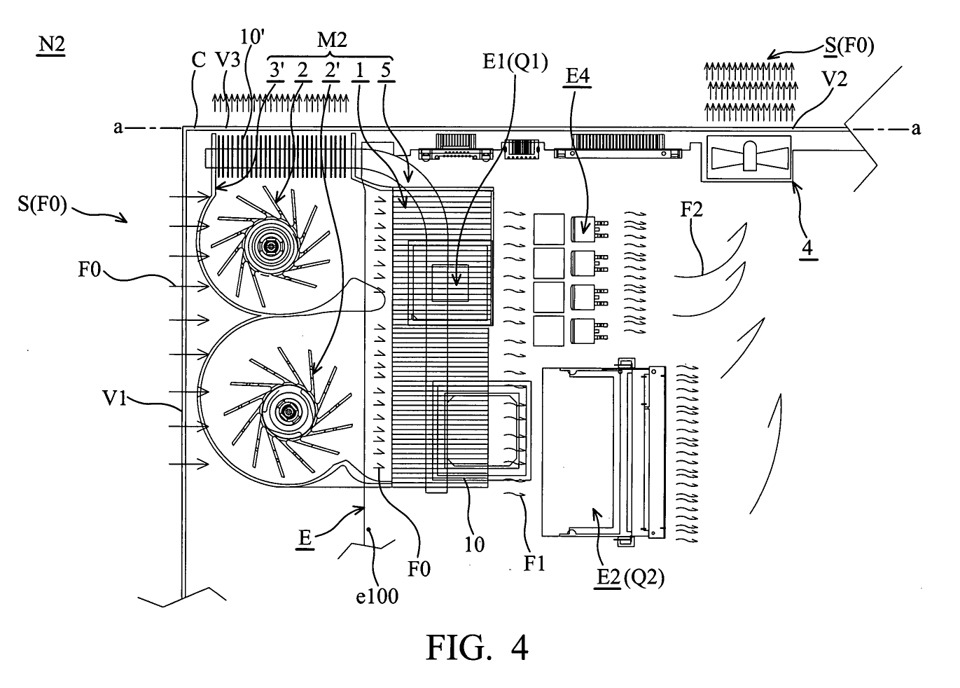

FIG. 4 is a perspective view of an electronic device N2 providing a heat-dissipating module M2 according to a second embodiment of the present invention.

The electronic device N2 differs from the electronic device N1 of the first embodiment in that a conductive pipe 5 and a heat-transfer unit 10′ are further provided in the housing C, and an outlet V3 is formed on the sidewall of the housing C with respect to the heat-transfer unit 10′. It is noted that a guide plate 3′ differs from the guide plate 3 in the first embodiment, by part thereof extending toward the outlet V3.

In this embodiment, in addition to the conductive assembly 1, the first fan assembly having two fan units 2/2′and the second fan assembly 4 mentioned above, the heat-dissipating module M2 further includes the conductive pipe 5 and the heat-transfer unit 10′. The heat-transfer unit 10′ comprises a fin structure disposed between the fan unit 2 of the first fan assembly and the outlet V3, and the conductive pipe 5 connects the heat-transfer unit 10′ to the heat-transfer unit 10. Heat from the first heat source Q1 is transmitted to the heat-transfer unit 10′ via the conductive pipe 5.

In addition to the heat-transfer unit 10, heat from the first heat source Q1 is also dissipated by the heat-transfer unit 10′ and the conductive pipe 5. As the fan unit 2 of the first fan assembly rotates, the initial airflow F0 also contacts the heat-transfer unit 10′ via the guide plate 3′, and further heat is dissipated and transmitted to the surroundings S via the outlet V3.

While the invention has been described in connection with what is presently considered to be the most practical and preferred embodiment, it is to be understood that the invention is not limited to the disclosed embodiments, but, on the contrary, is intended to accommodate various modifications and equivalent arrangements included within the spirit and scope of the appended claims.

1. An electronic device, located in surroundings providing an initial airflow, comprising:
a host, comprising a housing and a circuit having at least one first heat source and at least one second heat source disposed in the housing;
a display unit electronically connected to the circuit; and
a heat-dissipating module for providing heat transfer and convection to the surroundings, having at least one conductive assembly disposed on the first heat source to absorb heat transferring from the first heat source and at least one first fan assembly located between the surroundings and the conductive assembly, wherein the first fan assembly introduces the initial airflow of the surroundings into the conductive assembly to form at least one first airflow, and the first airflow passes the second heat source to form at least one second airflow, and temperature ingredient is yielded between the first airflow and the second airflow.

2. The electronic device as claimed in claim 1, wherein temperature of the first heat source does not exceed that of the second heat source.

3. The electronic device as claimed in claim 1, wherein the first fan assembly is disposed near one side of the housing.

4. The electronic device as claimed in claim 1, wherein the housing comprises an inlet, and the first fan assembly is disposed between the inlet and the conductive assembly.

5. The electronic device as claimed in claim 1, wherein the conductive assembly comprises a heat-transfer unit connected to the first heat source.

6. The electronic device as claimed in claim 5, wherein the heat-transfer unit comprises a fin structure.

7. The electronic device as claimed in claim 1, wherein the first heat source comprises a CPU.

8. The electronic device as claimed in claim 1, wherein the second heat source comprises a memory module.

9. The electronic device as claimed in claim 1, further comprising a conductive pipe transferring heat from the conductive assembly to one side of the first fan assembly.

10. The electronic device as claimed in claim 3, further comprising a second fan assembly disposed on one side of the housing conducting the second airflow to the surroundings.

11. The electronic device as claimed in claim 1, wherein temperature of the first airflow is higher than that of the second airflow.

12. A heat-dissipating module for providing heat transfer and convection on at least one first heat source and at least one second heat source located in a housing by an initial airflow of a surroundings, comprising:
at least one conductive assembly disposed on the first heat source to absorb heat transferring from the first heat source;
at least one first fan assembly located between the surroundings and the conductive assembly, wherein the first fan assembly introduces the initial airflow of the surroundings into the conductive assembly to form at least one first airflow, and the first airflow passes the second heat source to form at least one second airflow, and temperature ingredient is yielded between the first airflow and the second airflow.

13. The heat-dissipating module as claimed in claim 12, wherein temperature of the first heat source does not exceed that of the second heat source.

14. The electronic device as claimed in claim 12, wherein temperature of the first airflow is higher than that of the second airflow.

15. The electronic device as claimed in claim 12, wherein the housing comprises an inlet, and the first fan assembly is disposed between the inlet and the conductive assembly.

16. The electronic device as claimed in claim 12, wherein the conductive assembly has a heat-transfer unit connected to the first heat source.

17. The electronic device as claimed in claim 12, wherein the first heat source comprises a CPU.

18. The electronic device as claimed in claim 12, wherein the second heat source comprises a memory module.

19. The electronic device as claimed in claim 12, further comprising a conductive pipe transferring heat from the conductive assembly to one side of the first fan assembly.

20. The electronic device as claimed in claim 12, further comprising a second fan assembly disposed on one side of the housing conducting the second airflow to the surroundings.
